(19) United States
(12) Patent Application Publication
(10) Pub. No.: US 2008/0127845 A1
(43) Pub. Date: Jun. 5, 2008

(54) METHOD AND SYSTEM FOR PAD PRINTING WITH REMOVABLE PRE-FILLED INK CUP

(76) Inventors: CHRISTOPHER SCHAAFSMA, Wheaton, IL (US); Sigi Knappik, Schaumburg, IL (US); Christopher Williamson, Winfield, IL (US)

Correspondence Address: CARDINAL LAW GROUP, Suite 2000, 1603 Orrington Avenue, Evanston, IL, 60201, US

(21) Appl. No.: 11/929,042

(22) Filed: Oct. 30, 2007

Related U.S. Application Data
(60) Provisional application No. 60/867,991, filed on Nov. 30, 2006.

(51) Int. Cl. B41M 1/10

(52) U.S. Cl. 101/169; 101/170

(57) ABSTRACT

A method for operating a pad printing system includes receiving a removable pre-filled ink cup on a doctor assembly, orienting the removable pre-filled ink filled cup on the doctor assembly, and dispensing ink from the oriented removable pre-filled ink cup. A removable pre-filled ink cup is provided for a pad printing system including an ink retention portion pre-filled with ink, and a doctor assembly orientation portion formed on an outer portion of the retention portion, wherein the removable pre-filled ink cup is configured to deposit ink on a cliché device via a doctor assembly mated with the doctor assembly orientation portion.

### RELATED APPLICATIONS

This application claims priority to and the benefit of U.S. Provisional Patent Application 60/867,991 filed Nov. 30, 2006.

### TECHNICAL FIELD OF THE INVENTION

The present invention relates generally to printing and in particular to pad printing.

### BACKGROUND OF THE INVENTION

Pad printing has been used for many years to apply an image to a product. Pad printing is especially prevalent in applications for applying images to rounded products, such as syringes and sporting equipment. Pad printing is also effective on uneven surfaces, such as the dimpled surface of a golf ball.

Conventional pad printing systems use a deformable pad that receives ink, transferred as an image, from a flat cliché plate. The plate has an engraving or etching of the image formed therein. The etching results in recesses in a surface of the cliché plate for containing ink. The ink is transferred from a liquid supply assembly to the cliché plate where it fills the recesses. The deformable pad is then pressed onto the plate and ink within the liquid is picked up by the pad. The image is then transferred to the print surface.

To re-ink the pad, in a commonly used arrangement, an inverted cup containing a quantity of printing ink is used to apply the ink to the cliché plate. The cup and cliché plate are translated relative to each other whereby a coating of ink is deposited on the cliché plate as the portion of the cliché plate bearing the indicia travels adjacent the cup. A doctor blade is fitted to the cup to traverse along the cliché plate and “wipe” the excess ink from the cliché plate. The action of the doctor blade leaves behind the ink that fills the recesses in the etched area while removing the ink from areas not forming part of the image and where it would tend to buildup if not removed.

Conventionally, ink is poured from a shipping container, in which it was purchased, into a mixing container for mixing of the ink with a quantity of a thinner. The ink is transferred from the mixing container to the ink cup of the pad printing system and the mixing container is discarded. When the ink in the ink cup is depleted, the ink cup is cleaned and refilled. Cleaning of the cup can be costly in terms of the time, labor, and materials required to perform the operation. In addition, cleaning involves the handling of potentially noxious substances. Furthermore, the ink that remains in the mixing container is lost, since it is discarded along with the mixing container. Ink is also potentially lost when the ink is transferred from the container to the cup due to the risk of spillage.

It is, therefore, desirable to provide a method and system for pad printing that would overcome the aforementioned and other disadvantages.

### SUMMARY OF THE INVENTION

One aspect of the invention provides a method for operating a pad printing system including receiving a removable pre-filled ink cup on a doctor assembly, orienting the removable pre-filled ink filled cup on the doctor assembly, and dispensing ink from the oriented removable pre-filled ink cup.

Another aspect of the invention provides a system for operating a pad printing system including means for receiving a removable pre-filled ink cup on a doctor assembly, means for orienting the removable pre-filled ink cup on the doctor assembly, and means for dispensing ink from the oriented removable pre-filled ink cup.

A third aspect of the invention provides a pad printing system including a doctor assembly that includes a removable pre-filled ink cup receiving portion, wherein the receiving portion provides orientation of removable pre-filled ink cups.

A fourth aspect of the invention provides a removable pre-filled ink cup for a pad printing system including an ink retention portion pre-filled with ink, and a doctor assembly orientation portion formed on an outer portion of the retention portion, wherein the removable pre-filled ink cup is configured to deposit ink on a cliché device via a doctor assembly mated with the doctor assembly orientation portion.

The aforementioned and other features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 illustrates a flowchart of one example of a method for pad printing with removable pre-filled ink cup, in accordance with the invention;

FIG. 2 illustrates a schematic representative of one example of a pre-filled ink cup for a pad printing system, in accordance with the invention;

FIG. 3 illustrates a schematic representative of one example of a doctor assembly for a pad printing system, in accordance with the invention;

FIG. 4 illustrates a schematic representative of one example of a system for pad printing with removable pre-filled ink cup, in accordance with the invention.

### DETAILED DESCRIPTION OF THE PRESENTLY PREFERRED EMBODIMENTS

In the disclosure, the words “a” or “an” are to be taken to include both the singular and the plural. Conversely, any reference to plural items shall, where appropriate, include the singular.

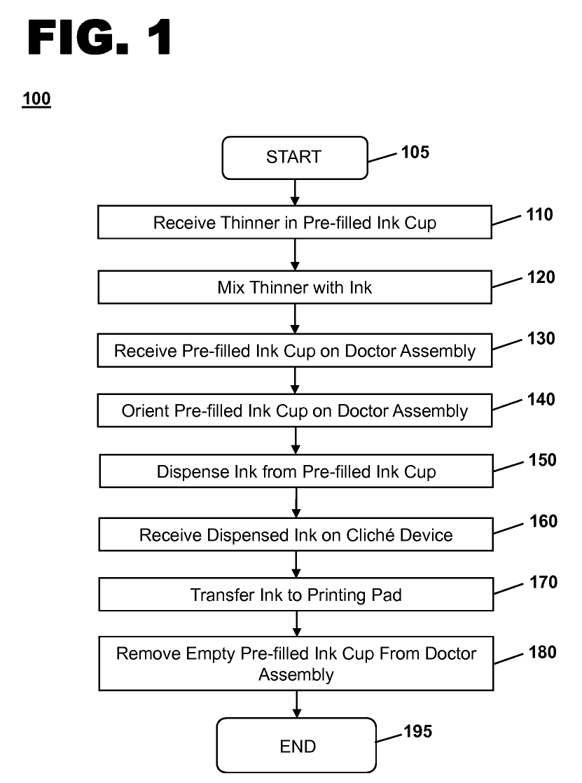

FIG. 1 illustrates a flowchart of one example of a method for pad printing with removable pre-filled ink cup, in accordance with the invention at 100. The method begins (block 105).

A volume of a thinner is received in a removable pre-filled ink cup (block 110). An exemplary removable pre-filled ink cup is cylindrical in shape and contains a volume of ink with an additional space, within the cup, reserved for the addition of the thinner. The removable pre-filled ink cup is manufactured typically of steel or of a rigid plastic. The material chosen must withstand the stresses applied to it in a pad printing system, such as contact with a cup stop device.

The thinner is mixed with the ink in the removable pre-filled ink cup (block 120). The thinner adjusts the ink to the desired viscosity for use in the pad printing system.

The removable pre-filled ink cup is received on a doctor assembly (block 130). The doctor assembly holds the ink cup in the pad printing system and is configured to allow the removable pre-filled ink cup to be attached and detached as needed.

The removable pre-filled ink cup is oriented on the doctor assembly (block 140). Various means for orienting the removable pre-filled ink cup on the doctor assembly are used. The doctor assembly provides the proper alignment of the removable pre-filled ink cup in the pad printing system.

Once the removable pre-filled ink cup is oriented on the doctor assembly, printing can commence. The ink is dispensed from the oriented removable pre-filled ink cup (block 150) and received onto a cliché device (block 160). The ink on the cliché device is then transferred to a pad (block 170) for application to a print object.

When the removable pre-filled ink cup is empty, it is removed from the doctor assembly (block 180). Upon removal, the now empty ink cup is discarded as required. Excess ink is cleaned from the doctor assembly before a new removable pre-filled ink cup is oriented on the doctor assembly.

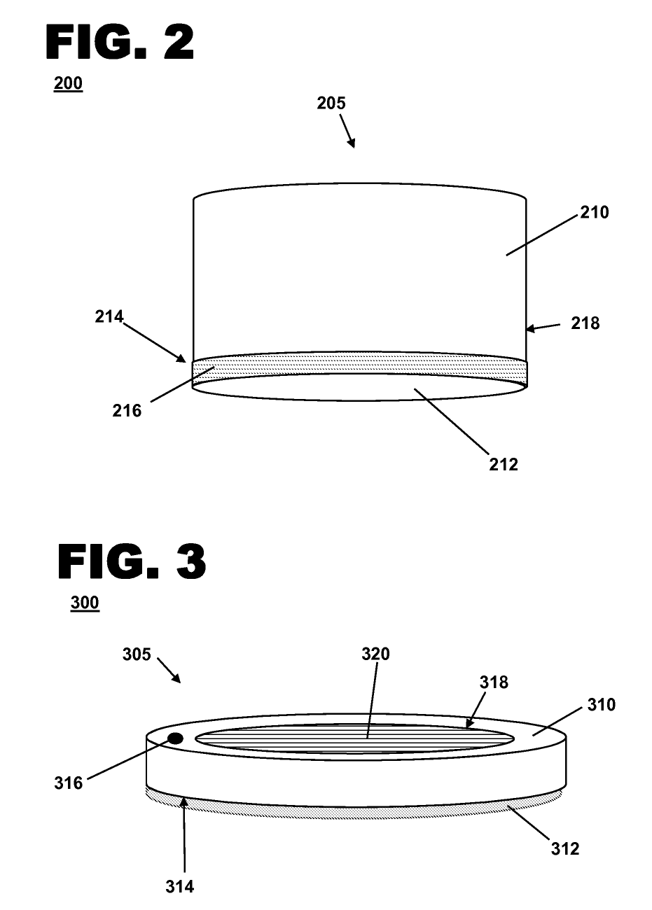

FIG. 2 illustrates a schematic representative of one example of a pre-filled ink cup for a pad printing system, in accordance with the invention at 200.

The pre-filled ink cup is a removable pre-filled ink cup 205 and includes an ink retention portion 210 pre-filled with a quantity of ink (not shown). The ink is supplied along with the removable pre-filled ink cup and the removable pre-filled ink cup is disposed of, once the ink is depleted. The removable pre-filled ink cup includes an opening 212 at one end for addition of a thinner and to permit the flow of ink in the pad printing system. A doctor assembly orientation portion 214 is disposed substantially adjacent opening 212. In one example, the doctor assembly orientation portion 214 is a threaded section 216 of an outer surface 218 of the removable pre-filled ink cup that enables insertion and removal of the removable pre-filled ink cup in the pad printing system.

The removable pre-filled ink cup is constructed of a material appropriate for the pad printing system taking into consideration various factors, such as ease of manufacture, cost of manufacture, compatibility with the ink and associated thinners, opportunity for recycling, weight, and structural stability. In one example the removable pre-filled ink cup is constructed of a metal, such as steel or aluminum. In another example the removable pre-filled ink cup is constructed of a plastic.

FIG. 3 illustrates a schematic representative of one example of a doctor assembly for a pad printing system, in accordance with the invention at 300.

The doctor assembly 305 includes an orientation unit, such as ring 310, a doctor blade 312 located on a lower surface 314 of ring 310, and at least one connection point 316 for connecting the doctor assembly to the pad printing system.

A removable pre-filled ink cup receiving portion 318 is disposed on doctor assembly 305. In one example, the removable pre-filled ink cup receiving portion 318 is a threaded inside surface 320 of ring 310. Threaded inside surface 320 is configured for receiving removable pre-filled ink cup 205, shown in FIG. 2, on doctor assembly 305. The removable pre-filled ink cup is oriented by engaging the threaded section of the outer surface of the removable pre-filled ink cup with the threaded inside surface of the ring.

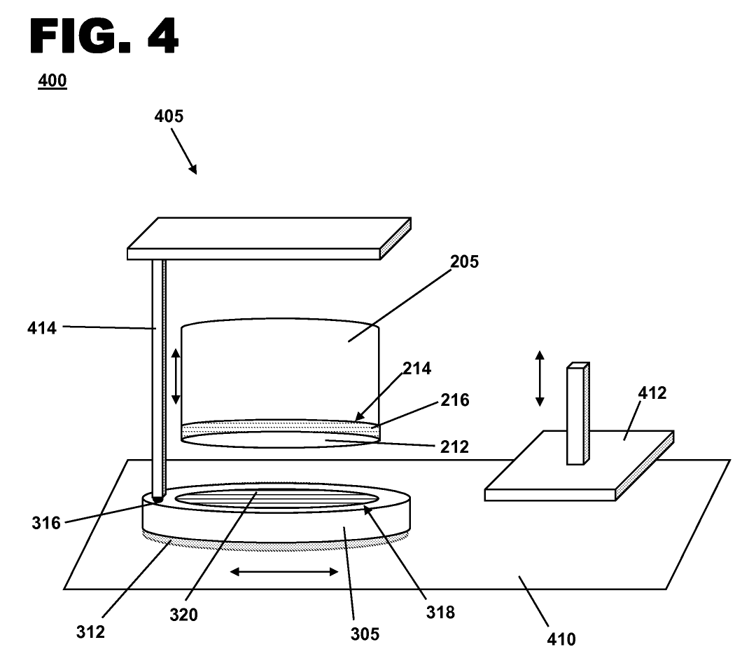

FIG. 4 illustrates a schematic representative of one example of a system for pad printing with pre-filled ink cup, in accordance with the invention at 400.

The pad printing system 405 includes a cliché device 410, a printing pad 412, doctor assembly 305, pre-filled ink cup 205, and a mounting unit 414.

Removable pre-filled ink cup 205 is received by removable pre-filled ink cup receiving portion 318 of doctor assembly 305 in an inverted position, whereby opening 212 is substantially adjacent cliché device 410. Doctor assembly orientation portion 214 of the removable pre-filled ink cup corresponds to the removable pre-filled cup receiving portion 318 on the doctor assembly. The two corresponding sections are aligned so that, in one example, threaded portion 216 of removable pre-filled ink cup 205 engages threaded inside surface 320 of ring 310, providing orientation of the removable pre-filled ink cup on the doctor assembly within the pad printing system

In one example, the doctor assembly orientation portion of the removable pre-filled ink cup and the removable pre-filled ink cup receiving portion of the doctor assembly include corresponding interlocking portions for orienting the removable pre-filled ink cup on the doctor assembly. In another example, corresponding clamping portions are included for orienting the removable pre-filled ink cup on the doctor assembly. Various other means, not listed, for orienting the two parts are also used.

Mounting unit 414 is a structure suitable for mounting doctor assembly 305, with removable pre-filled ink cup 205 oriented thereon, in pad printing system 405. The mounting unit can be integrated with a push rod, a suspension system, a hold down unit, or other structure within the pad printing system.

In one example, the removable pre-filled ink cup includes an annular doctor blade affixed adjacent opening 212. In this example, the removable pre-filled ink cup, with the included annular doctor blade, comprises the doctor assembly. The removable pre-filled ink cup, with the included annular doctor blade, is located on mounting unit 414 of the pad printing system.

Ink flows by gravity from the removable pre-filled ink cup onto cliché device 410. Doctor blade 312 provides a seal between doctor assembly 305 and cliché device 410. In addition, the doctor blade wipes excess ink from cliché device 410 as the doctor assembly and the cliché device are translated relative to one another. The ink remaining on the cliché device, after doctoring, is transferred to printing pad 412 by pressing the printing pad against the inked cliché device. The printing pad with the transferred ink is separated from the cliché device for subsequent transfer of the ink to a print object (not shown).

It is important to note that the figures and description illustrate specific applications and embodiments of the present invention, and is not intended to limit the scope of the present disclosure or claims to that which is presented therein. Upon reading the specification and reviewing the drawings hereof, it will become immediately obvious to those skilled in the art that myriad other embodiments of the present invention are possible, and that such embodiments are contemplated and fall within the scope of the presently claimed invention.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

What is claimed is:

1. A method of operating a pad printing system, the method comprising:
receiving a removable pre-filled ink cup on a doctor assembly;
orienting the removable pre-filled ink filled cup on the doctor assembly; and
dispensing ink from the oriented removable pre-filled ink cup.

2. The method of claim 1 further comprising:
removing an empty removable pre-filled ink cup from the doctor assembly.

3. The method of claim 1 further comprising:
receiving the dispensed ink on a cliché device; and
transferring the dispensed ink to a printing pad.

4. The method of claim 1 further comprising:
receiving a volume of a thinner in the removable pre-filled ink cup; and
mixing the received volume of the thinner with ink in the removable pre-filled ink cup.

5. The method of claim 1, wherein orienting the removable pre-filled ink cup on the doctor assembly comprises engaging a threaded portion of the removable pre-filled ink cup with a threaded inner surface of the doctor assembly.

6. A system for operating a pad printing system, the system comprising:
means for receiving a removable pre-filled ink cup on a doctor assembly;
means for orienting the removable pre-filled ink cup on the doctor assembly; and
means for dispensing ink from the oriented removable pre-filled ink cup.

7. A pad printing system, comprising:
a doctor assembly including a removable pre-filled ink cup receiving portion, wherein the receiving portion provides orientation of removable pre-filled ink cups.

8. The system of claim 7, further comprising:
a removable pre-filled ink cup including ink; and
a cliché device, wherein the doctor assembly dispenses ink from the removable pre-filled cup onto the cliché device.

9. The system of claim 7, further comprising:
a doctor blade operably connected to the doctor assembly.

10. The system of claim 7, further comprising:
a mounting unit, wherein the doctor assembly is operably connected to the mounting unit.

11. The system of claim 7, wherein the doctor assembly is a ring; and the removable pre-filled ink receiving portion is a threaded inner surface of the doctor assembly.

12. The system of claim 8, wherein the removable pre-filled ink cup comprises the doctor assembly.

13. A removable pre-filled ink cup for a pad printing system, comprising:
an ink retention portion pre-filled with ink; and
a doctor assembly orientation portion formed on an outer portion of the retention portion, wherein the removable pre-filled ink cup is configured to deposit ink on a cliché device via a doctor assembly mated with the doctor assembly orientation portion.

14. The system of claim 13 wherein the ink retention portion comprises the doctor assembly.
